(19) United States
(12) Patent Application Publication
(10) Pub. No.: US 2012/0253536 A1
(43) Pub. Date: Oct. 4, 2012

(54) AC DIVERSION MODE CONTROLLER

(75) Inventors: Brian J. Faley, Mount Vernon, WA (US); Clyde Yamamoto, Edmonds, WA (US)

(73) Assignee: Magnum Energy, Incorporated, Everett, WA (US)

(21) Appl. No.: 13/511,124

(22) PCT Filed: Dec. 21, 2010
(86) PCT No.: PCT/US10/61504

§ 371 Date: May 21, 2012

Related U.S. Application Data
(60) Provisional application No. 61/289,290, filed on Dec. 22, 2009.

(51) Int. Cl. G06F 1/26

(52) U.S. Cl. 700/295

(57) ABSTRACT

A circuit that includes a battery monitoring circuit structured to monitor at least one from among power grid current, battery output current, and time and to determine at least one of a battery charging profile and a battery type, and to output a digital communication data stream; and a controller coupled to the power grid and to the battery monitoring circuit to receive the data stream and to output a control signal to direct all or a proportion of the power grid current to a diversion load.

### BACKGROUND

1. Technical Field

The present disclosure pertains to micro grid power systems and, more particularly, to a system for controlling diverted AC energy.

2. Description of the Related Art

FIG. 1 illustrates an AC coupled micro grid power system 10, which can include at least one four-quadrant battery inverter 12 connected to a battery system or series-connected batteries 14 on a direct current (DC) side of the inverter 12 and to a power grid 16 on the alternating current (AC) side of the inverter 12. At least one grid tie inverter 18, which is coupled to a DC producing renewable energy source, such as a photovoltaic panel (PV panel) 20 on one side, is also coupled to the grid 16 on an AC side of the inverter 18. The grid tie inverter 18 uses the battery inverter 12 as its grid reference. If local AC loads 22 coupled to the power grid 16 are not sufficient to consume all of the energy produced by the grid tie inverters 18, the battery based inverter 12 will be back-fed by the surplus current, shown as “Energy Flow” above the directional arrow in FIG. 1. In other words the battery will attempt to accept the AC current from the grid tie inverters by recirculating it through the battery inverter transformer and semiconductors. A typical four quadrant inverter will convert the surplus AC energy into

DC, in an uncontrolled manner. In this operating mode, the battery based inverter 12 behaves as a battery charger; however, because the output voltage regulation is the key parameter regulated by the inverter 12, any battery charging will proceed in an uncontrolled fashion—dictated by the transformer turns ratio in the battery inverter 12. Consequently, as the grid tie inverters 18 attempt to push current into the output of the battery inverter 12, the battery voltage will rise, as indicated in FIG. 1 by the legend “Voltage Rise” above the vertical arrow, resulting in an undesirable overcharge situation.

Previous AC coupled inverter systems attempted to prevent battery overcharging by adding a diversion load 24 on the DC side of the system across the battery 12 as shown in FIG. 2. Simple systems utilized a voltage sensing relay or command signal from a voltage sensor to connect a DC resistive load 24 to the battery 12. More sophisticated systems utilized charge controllers connected as the diversion regulator to pulse width modulate the diversion load, allowing accurate battery voltage regulation. However, in large systems, the cost of the DC control circuitry and DC resistive loads is high because of the amount of current being diverted. Such systems often require more than one charge controller to handle the current by splitting up the load into smaller loads within the rating of the charge controllers.

Another known method to protect the battery from over voltage consists of having the battery based inverter monitor the battery voltage and shift the ac output frequency in an attempt to force any grid tie inverters off-line when the battery voltage rises above a set point. A grid tie inverter must respond to a frequency shift of ±0.5 Hz by disconnecting from the AC power source. Hence in a system as described, a grid tie inverter would cease to push the battery above the limit set by the inverter's frequency shift set point. Once the battery voltage falls below a maximum battery threshold (typically with some hysteresis to prevent rapid cycling), the grid connected inverter would attempt to reconnect, and the cycle would repeat itself, with the grid tie inverters alternately causing the battery voltage to fluctuate between two limits at the upper end of operation for the inverter.

If the system were to contain either a small battery bank with respect to the grid tie inverters that arc available, or a large number of grid tie inverters or inverters having a large rating, the system battery voltage could cycle on a 5 minute basis. It is unlikely that damage would occur, since the battery based inverter would protect against over voltage from the battery. But the total available renewable resource would spend substantial time offline.

In systems where the renewable source is directly connected to a grid tied inverter, such as an integrated wind turbine/ac inverter, the fluctuating operation caused by the 5 min on/off cycling could cause significant mechanical wear and tear as the system could transition from full load to unloaded in a single cycle of the AC output. In such a system, a constant load for the turbine is desirable.

Constant power sources like micro hydro generators and small wind turbines require connection to a load that will absorb all the power that they generate. They cannot utilize a system which simply turns off the grid tie inverters. The turbines must have a load connected at all times to protect the turbine from over-speed and self-destruction conditions. Typically such systems utilize a ‘diversion load’ to absorb any energy beyond that required by the useful load that they are powering. Most small systems use the battery as the point of common coupling, with rectifiers converting the output of the turbine or hydro and charging the battery through a three phase rectifier.

DC side diversion mode controllers typically utilize a charge controller in series with a DC load having sufficient capacity to absorb the total output of the turbine or hydro. The DC side mode controllers serve two functions: (1) to protect the turbine against over-speed, and (2) to protect the battery by diverting any surplus current to a dump load when the battery is fully charged.

### BRIEF SUMMARY

The present disclosure addresses the need for a diversion load to absorb any surplus energy from the renewable system while at the same time regulating the charging of the battery in the mode where the inverter is not operating as a battery charger per se.

Also, the present disclosure diverts the power in a proportional way, so as to maintain a smooth and continuous load from no load to full load for the renewable portion of the system. This allows the renewable resource to continue to produce energy even if the battery is full. The present disclosure also applies the diversion load to the AC output of the renewable system. This mode of interconnecting inverters on the AC side of the system is called “AC-coupling” because the common point of interconnection of the inverters is the AC output. Unlike systems that use a diversion load on the battery side of the system, this AC diversion load does not stress the inverter by forcing it to process the surplus power, thus reducing wear and tear on the inverter and allowing a smaller inverter to form the reference for a much larger system made up of larger grid tie inverters.

In accordance with one embodiment of the present disclosure, a circuit is provided that includes a battery monitoring circuit structured to monitor at least one from among power grid current, battery output current, and time and to determine at least one of a battery charging profile and a battery type, and to output a digital communication data stream; and a controller coupled to the power grid and to the battery monitoring circuit to receive the data stream and to output a control signal to direct all or a proportion of the power grid current to a diversion load.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is a diagram of a known micro grid power system;

FIG. 2 is a diagram of another known micro grid power system;

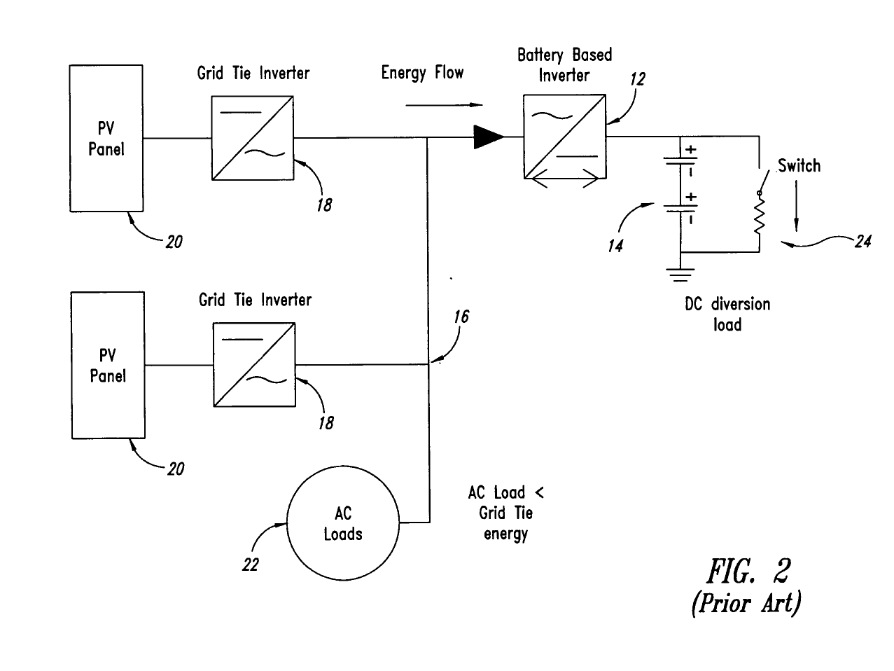

FIG. 3 is a diagram of a circuit of the present disclosure;

FIG. 4 is a diagram illustrating further details of the circuit of FIG. 3;

FIG. 5 is a schematic of a further circuit formed in accordance with the present disclosure; and

FIG. 6 is a schematic of a diversion mode controller formed in accordance with another aspect of the present disclosure.

### DETAILED DESCRIPTION

In the following description, certain specific details are set forth in order to provide a thorough understanding of various embodiments of the disclosure. However, one skilled in the art will understand that the disclosure may be practiced without these specific details. In other instances, well-known structures associated with micro grid power systems, such as inverters, grid tie inverters, batteries, and related components have not been described in detail to avoid unnecessarily obscuring the descriptions of the embodiments of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.” In addition, the term “grid tied” will be used synonymously with “grid tie” throughout this specification.

In addition, reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. In the drawings, identical reference numbers identify similar features or elements. The size and relative positions of features in the drawings are not necessarily drawn to scale. For example, the shapes of various features are not drawn to scale, and some of these features are enlarged and positioned to improve drawing legibility.

The headings herein are for convenience only and do not interpret the scope or meaning of the embodiments.

In accordance with one embodiment of the present disclosure, an error amplifier is provided that compares the battery voltage to a predetermined set point as determined by the battery type and charging profile. The preferred method is to use a three stage battery charging algorithm, which senses both the battery charging current, (in this case reverse inferred from AC output current), battery voltage, and time.

Generally, a power factor corrected AC to DC converter, which receives the AC line current and operates under control from the battery information and adjusts the current drawn from the line to hold the battery voltage at its reference level using feedback. An average current mode control scheme is utilized to improve power factor to greater than 0.9 for the diversion load to reduce waveform distortion as much as possible and thereby avoid disturbing the inverter low harmonics.

A load, which may contain resistors, or any utility voltage load with sufficient capacity, is provided to dissipate the total energy produced by the grid tie inverters in the system. Standard water or space heater elements may be utilized to receive the energy in a useful application.

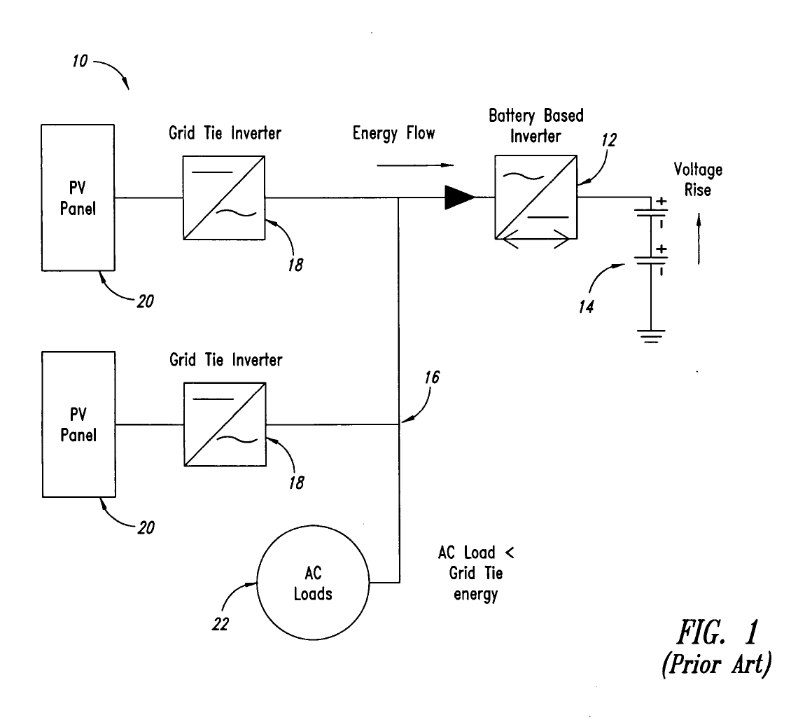

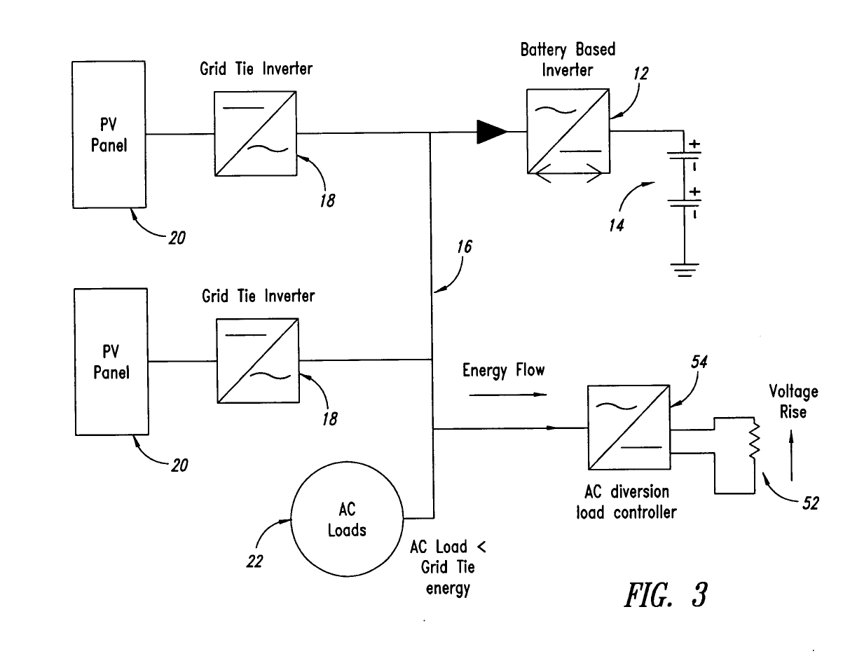

Referring to FIG. 3, shown therein is a system 50 in which components or elements that are carried over from the system 10 of FIG. 1 are denoted with like reference numbers. In this embodiment of the present disclosure, the system 50 includes an AC diversion load 52, illustrated here as a resistor or resistive element. It is to be understood that other known load elements may be used as will be readily ascertainable by one of skill in this technology. Coupled to the diversion load 52 is an AC diversion load controller 54. Although the controller 54 is illustrated with the inverter symbol, it is to be understood that the controller 54 can be characterized in several forms, as will be described in more detail herein.

The AC diversion mode controller 54 consists of a means to monitor battery inverter output current, battery voltage, and battery type. The preferred embodiment of the device would have those signals communicated digitally from the battery inverter 12, hence requiring no further sensors. It is within the scope of the present disclosure to provide those signals if an inverter does not provide them.

In this operating mode, as the grid tie inverters 18 attempt to push current into the output of the battery inverter 12, the battery voltage will be directed in whole or in part to the diversion load 52, as indicated in FIG. 3 by the legend “Energy Flow” above the arrow pointing in to the controller 54. The resultant voltage over the diversion load 52 is denoted with the legend “Voltage Rise” above the vertical arrow adjacent the diversion load 52 in FIG. 3. This avoids the undesirable effects of the overcharge situation that was described above with respect to the circuit of FIG. 1. It is to be understood that the directed flow of the energy to the diversion load 52 occurs when the AC load is less than the grid tie energy, as indicated in text at the bottom of FIG. 3.

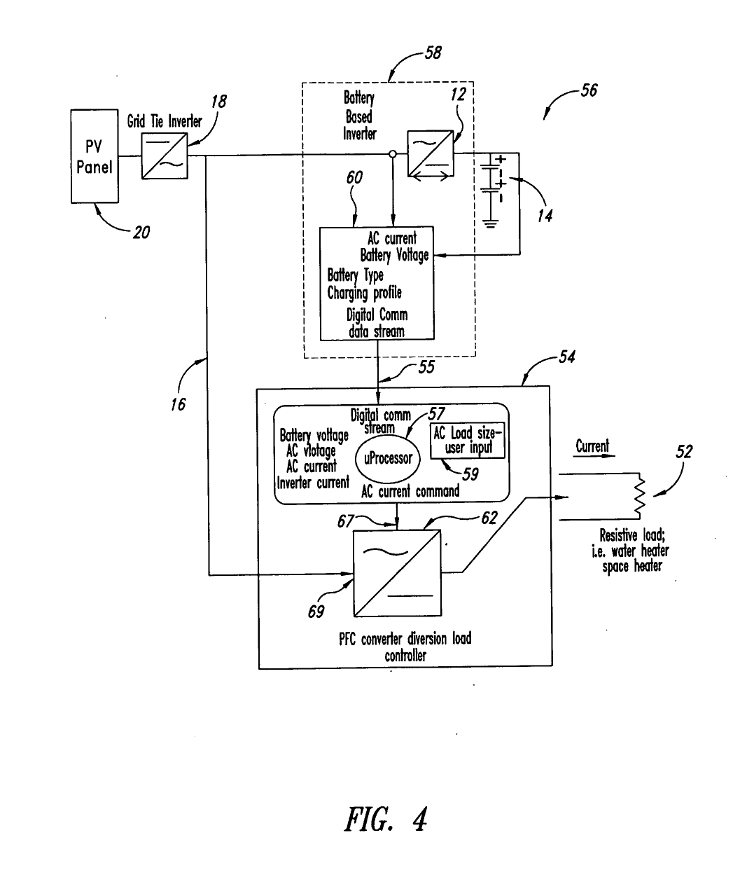

Referring next to FIG. 4, shown therein in more detail is one embodiment of the present disclosure in which the system 56 is shown to have a representative PV panel 20 coupled to a representative grid tie inverter 18. Multiple panel-and-inverter pairs can be used in this situation, although only one pair 18, 20 is shown for exemplary purposes.

A modified battery based inverter 58 is shown in dashed lines to include the inverter 12, battery system 14, and a battery monitoring circuit 60 having a first input coupled to the AC side of the battery inverter 12, a second input coupled to the DC side of the inverter 12, and a data stream output coupled to the AC diversion load controller 54.

The battery monitoring circuit 60 receives AC current on a first input 61, DC battery voltage on a second input 63 and processes the signals received on these two inputs 61, 63 to monitor AC current on the grid 16, battery output current, and time and to determine at least one of the battery charging profile and battery type. The data stream output from the battery monitoring circuit 60 is received at a first input or process 55 of the AC diversion load controller 54. Preferably, an average current mode control scheme is utilized to improve the power factor to greater than 0.75 and preferably greater than 0.9 for the diversion load in order to reduce waveform distortion as much as possible and avoid disturbing the inverter's low harmonics.

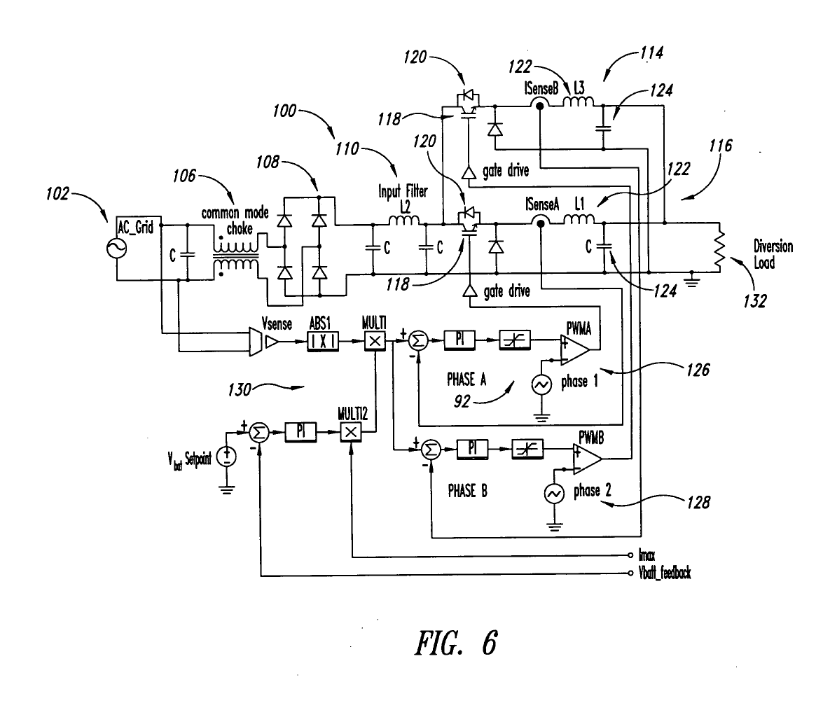

As further shown in FIG. 4, a control circuit 62 receives an AC current command on a first input 67 and has a second input 69 coupled to the AC grid to receive the AC current. In the embodiment shown in FIG. 6, the AC current command signal is generated on an output of a multiplier, such as MULTI shown in FIG. 6. This signal is used by the power factor correction circuits, i.e., the summer, the PI controller, and the PWM circuit.

These signals are processed by the Power Factor Corrected (PFC) converter diversion load control circuit 62, which directs all or a proportion of current to the resistive load 52. As stated above, the load may contain resistors or consist of any utility voltage load with sufficient capacity to dissipate the total energy produced by the grid tie inverters in the system or, as indicated in FIG. 4, the resistive load 52 can be a useful load, such as a water heater, space heater, and the like.

Ideally, a user interface 59 is provided that enables setting of a maximum load current through the resistive load 52 to prevent improper operation or overload. The PFC controller microprocessor 57 utilizes data provided by the digital communication as shown in the bubble inside the boxed area for the PFC diversion load controller 54. The data stream, the AC current command, and the input from the optional external current and voltage sensors are all used by the PFC controller 54 to determine actions to be taken within the diversion load. This is more fully shown in the detailed circuit schematic of FIG. 6.

The power factor corrected AC to DC converter 62, which receives the AC line and operates under control from the battery monitoring circuit data stream information, adjusts the current drawn from the grid line 16 to hold the battery voltage at its reference level by using feedback.

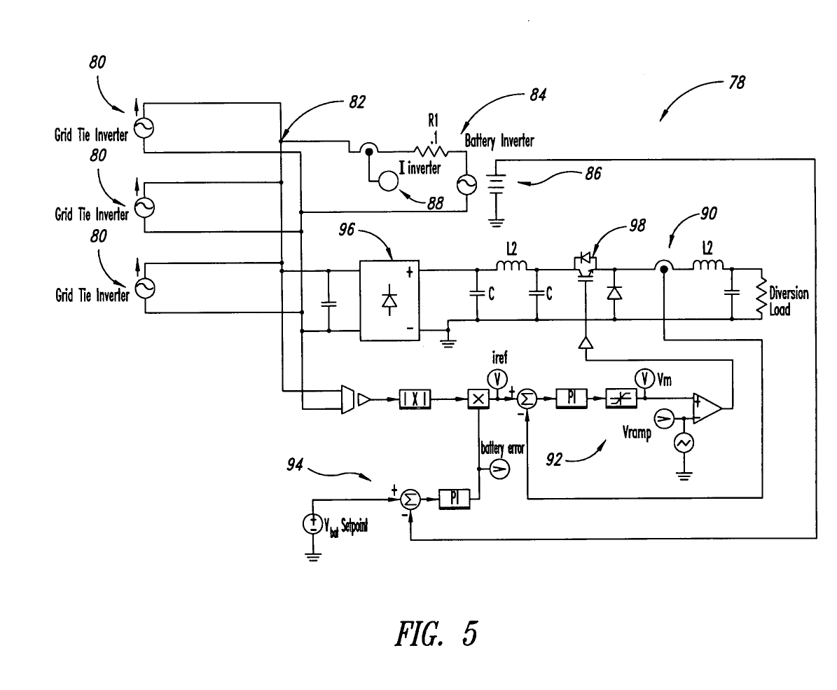

FIG. 5 is a circuit schematic of one embodiment of a system 78 formed in accordance with the present disclosure. Three Grid Tie Inverters 80 are coupled to a grid line 82 on the AC side thereof. On the DC side of the grid line 82 , a battery inverter 84 is coupled to a battery 86, and an indicator lamp 88 is provided in the inverter 84. A buck PFC power stage 90 is provided, and it is coupled to a PFC feedback control circuit 92. An output magnitude control circuit 94 is coupled to the battery 86 and the feedback control circuit 92. A rectifier circuit 96 couples the power stage 90 to the grid 82. A switching transistor 98 in the power stage 90 has its gate coupled to the feedback control circuit 92.

Referring next to FIG. 6, shown therein is a diversion mode controller 100 formed in accordance with another aspect of the present disclosure. The controller 100 includes the following components: (1) An EMI filter 110, to reduce any high frequency switching harmonics produced by the controller's converter. (2) A bridge rectifier 108 to convert the incoming AC to full wave rectified DC. (3) A second filter stage 106 to reduce switching frequency ripple while substantially leaving the full waved rectified sine wave undistorted so that it achieves high power factor. (4) An interleaved buck PFC power stage consisting of two identical converters 114, 116 operated 180 degrees out of phase to suppress input current ripple. (5) Each buck converter 114, 116 consists of a switching transistor 118 in series with a high speed diode 120 (or transistor/diode parallel combination to allow synchronous rectification), an inductor 122, and a capacitor 124 that receives the pulse width modulated output of the buck converter 114, 116 and integrates it into a full wave rectified DC signal proportional to the input waveform. (6) A PFC feedback control circuit 126, 128 for each buck converter 114, 116 to force the output current in each inductor to match the shape of the full wave rectified grid. In the preferred embodiment, average current mode control with a fixed frequency oscillator is used to control each buck converter.

Also included is (7) An output current magnitude control circuit 130 to cause the output current to be adjusted by the battery voltage on the grid reference inverter. The magnitude of the current controlled by each of the interleaved buck power stages 114, 116 is set by a voltage command and a maximum current command. The command signals are provided by a microprocessor control system (shown in FIG. 4), which receives battery voltage, inverter output current, battery type, battery temperature, monitor the battery voltage by communicating over a digital communications bus common to the inverter and diversion load controller.

Additionally, battery state of charge information may be provided by a system battery monitor, and generator run information in the case of systems that contain a back-up generator.

All of the communications are digitally transmitted between the various parts of the system. In the event that a third party inverter is used as the grid reference, the battery voltage information may be measured and transmitted by a stand-alone battery monitor.

In addition, a diversion load 132 is provided. In a preferred embodiment, this is a large power resistor. It could be a water heater element, or other space heater element sized to be at least equal to the total input power from the grid tied inverters feeding the AC coupled inverter system.

The signal Vbatt_feedback is provided by data generated by an AID converter in the battery-based inverter. The signal Imax is a user settable constant that is used to set a maximum current of the diversion load 132. Because resistive loads are user provided, as indicated above, provision for setting the maximum load current must be included to prevent improper operation or overload.

The other circuit elements that are shown but not described herein are known, commercially available components that are readily understood from their schematic symbols by one of ordinary skill in this technology. Briefly, these include, without limitation, pulse width modulation amplifiers PWMA, PWMB, multipliers MULT1, MULT2, and a summer.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A circuit, comprising:
a battery monitoring circuit configured structured to monitor at least AC power grid current, battery output current, and battery voltage and to determine at least a battery charging profile and a battery type, and to output a digital communication data stream; and
a controller coupled to the power grid and to the battery monitoring circuit and configured to receive the data stream and to output a control signal to direct all or a proportion of the power grid current to a diversion load.

2. The circuit of claim 1, wherein the battery monitoring circuit comprises a first input structured to receive the AC power grid current, a second input structured to receive DC battery output current, and a processor coupled to the first and second inputs and configured structured to determine at least a battery charging profile and to generate the data stream.

3. The circuit of claim 2, wherein the controller has an input configured to receive the data stream from the battery monitoring circuit, and the controller is configured to utilize an average current mode control process to divert current to the diversion load when an AC grid load is less than grid tie energy.

4. The circuit of claim 3, wherein the controller is configured to obtain a power factor of at least greater than 0.75 for the diversion load.

5. The circuit of claim 3, wherein the controller is configured to obtain a power factor greater than 0.90 for the diversion load.

6. The circuit of claim 2, wherein the processor is configured to generate an AC current command signal and the controller comprises a control circuit having first and second inputs structured to receive the AC current command signal and to receive the AC power grid current, respectively, the control circuit configured to adjust the AC power grid current drawn on the second input to hold the battery voltage at a reference level.

7. The circuit of claim 6, wherein the controller has an input structured to receive the data stream and the controller is configured to utilize an average current mode control process to divert current to the diversion load when an AC grid load is less than grid tie energy.

8. The circuit of claim 7, wherein the controller is configured to obtain a power factor at least greater than 0.75 for the diversion load.

9. The circuit of claim 7, wherein the controller is configured to obtain a power factor at least greater than 0.90 for the diversion load.

10. The circuit of claim 6, comprising a user interface coupled to the processor, and the processor is configured to enable user setting of a maximum load current to the diversion load.

11. The circuit of claim 1, comprising:
a battery inverter configured to receive AC power grid current and to output DC current;
a power stage configured to receive AC power grid current through a rectifier circuit and coupled to a feedback control circuit via a switching transistor having a control terminal coupled to an output of the feedback control circuit; and
an output current magnitude control circuit coupled to the feedback control circuit and configured to receive battery voltage and to adjust output current based on the battery voltage.

12. The circuit of claim 11, comprising a battery coupled to the battery inverter.

13. The circuit of claim 12, wherein the diversion load is coupled to the power stage.

14. The circuit of claim 13, wherein the diversion load comprises a resistive load.

15. A circuit for use with a battery coupled to a power grid and a diversion load, the circuit comprising:
a battery inverter configured to receive AC power grid current and to output DC current to the battery;
a power stage configured to receive AC power grid current and coupled to a feedback control circuit via a switching transistor having a control terminal coupled to an output of the feedback control circuit; and
an output current magnitude control circuit coupled to the feedback control circuit and configured to receive battery voltage and to adjust output current to the diversion load based on the battery voltage.

16. The circuit of claim 15, wherein the power stage is configured to receive AC power grid current through a rectifier circuit.

17. The circuit of claim 16, wherein the power stage is coupled to the diversion load.

18. The circuit of claim 17, wherein the diversion load comprises a resistive load.

19. A circuit for managing power grid energy, comprising:
an EMI filter configured to receive AC grid current, the EMI filter further configured to reduce high frequency switching harmonics;
a bridge rectifier coupled between the EMI filter and the AC grid current and configured to convert the AC grid current to full wave rectified DC current;
a second filter stage coupled between the bridge rectifier and the AC grid current and configured to reduce switching frequency ripple while substantially leaving the full wave rectified sine wave undistorted to achieve a high power factor;
an interleaved buck power stage circuit comprising first and second converters coupled to the EMI filter and configured to operate 180 degrees out of phase to suppress input current ripple; and
first and second feedback control circuits coupled to the first and second converters and configured structured to force output current from each converter to match a shape of the full wave rectified AC grid current.

20. The circuit of claim 19, comprising an output current magnitude control circuit coupled to the feedback control circuits and configured structured to cause output current of the circuit to be adjusted by battery voltage.

21. The circuit of claim 20, comprising a diversion load coupled to the first and second converters and configured to dissipate total grid tie inverter energy in response to control signals from the output current magnitude control circuit.

22. The circuit of claim 21, wherein each converter comprises a switching transistor coupled in series with a high speed diode and configured to allow synchronous rectification, and an inductor and capacitor that receive pulse width modulated output and configured to integrate it into a full wave rectified DC signal proportional to the input wave form.

23. The circuit of claim 22, comprising a battery coupled to the output current magnitude control circuit and configured to receive AC power grid current and voltage.

24. The circuit of claim 23, comprising a diversion load coupled to the first and second converters.

25. The circuit of claim 24, wherein the diversion load comprises a resistive load.

26. The circuit of claim 25, comprising a user interface coupled to an A/D converter coupled to the battery and to a processor, the processor configured to enable user setting of maximum load current through the diversion load.
